(19) United States
(12) Patent Application Publication
(10) Pub. No.: US 2009/0019404 A1
(43) Pub. Date: Jan. 15, 2009

(54) METHOD FOR CALCULATING DIFFICULTY LEVEL OF ROUTING IN NETLIST

(75) Inventor: Toshiyuki SADAKANE, Tokyo (JP)

Correspondence Address: MCDERMOTT WILL & EMERY LLP, 600 13TH STREET, N.W., WASHINGTON, DC, 20005-3096, US

(73) Assignee: RENESAS TECHNOLOGY CORP.

(21) Appl. No.: 12/169,481

(22) Filed: Jul. 8, 2008

(30) Foreign Application Priority Data
Jul. 13, 2007 (JP) JP2007-184121

(51) Int. Cl. G06F 17/50

(52) U.S. Cl. 716/4; 716/12

(57) ABSTRACT

The invention provides a method capable of calculating a difficulty level of routing at a high processing speed with good calculating accuracy. The method involves: performing hierarchical clustering on cells in a netlist so as to successively group the cells to be connected to each other through a larger number of nets (S1); allowing the nets in the netlist to belong to any of hierarchical layers of the hierarchical clustering so as to allow the nets in the netlist to belong to the “n”th hierarchical layer when a group that collectively includes all the cells connected to the nets is present in groups on the “n”th hierarchical layer, but is absent in groups on the “(n−1)”th hierarchical layer (S2); setting estimated values of lengths of routing in the nets in the netlist at a smaller value as the hierarchical layer to which the nets belong is lower in order (S3); summing the estimated values of the lengths of routing in the nets in the netlist on the basis of the setting to calculate an estimated value of a total length of routing in the netlist (S4); and dividing a result of the calculation by a circuit scale in the netlist to calculate a difficulty level of routing in the netlist (S5).

### BACKGROUND OF THE INVENTION

1. Field of the Invention

The present invention relates to a method for calculating a difficulty level of routing in a netlist.

2. Description of the Background Art

Conventionally, LSI is designed in accordance with a flow of processes of: performing RTL design; performing logic synthesis; performing layout design; calculating a difficulty level of routing on the basis of a result of the layout design; and determining the difficulty level of routing on the basis of a result of the calculation of the difficulty level of routing. As a result of the determination of the difficulty level of routing, if the difficulty level of routing has a value higher than a reference value, the RTL design is modified. Then, the processes described above are newly executed on the basis of the modified RTL design. The processes described above are repeatedly executed until the value of the difficulty level of routing becomes lower than the reference level finally.

As a method for calculating the difficulty level of routing, herein, there has been known a method for calculating the difficulty level of routing by means of high-speed placement and routing (refer to, e.g., Japanese Patent Application Laid-Open No. 2005-316647). In this calculating method, a high-speed placement and routing engine, which is normally installed in a layout design tool, is used for performing layout design on the basis of a netlist obtained as a result of the logic synthesis, and the difficulty level of routing is calculated on the basis of the layout design.

As another method for calculating the difficulty level of routing, moreover, there has also been known a method for calculating the difficulty level of routing on the basis of the number of fanouts. This calculating method is based on a concept that as the number of fanouts (the number of input pins to be connected) in a net is larger, a length of routing in the net becomes longer, which makes a routing operation difficult to perform. In this calculating method, an average value of the number of fanouts per one net is used as the difficulty level of routing with respect to the netlist obtained as a result of the logic synthesis.

The foregoing method for calculating the difficulty level of routing by means of the high-speed placement and routing has an advantage of good calculating accuracy, but has a disadvantage of low processing speed.

On the other hand, the foregoing method for calculating the difficulty level of routing on the basis of the number of fanouts has an advantage of high processing speed, but has a disadvantage of poor calculating accuracy.

### SUMMARY OF THE INVENTION

An object of the present invention is to provide a method capable of calculating a difficulty level of routing at a high processing speed with good calculating accuracy.

A method for calculating a difficulty level of routing in a netlist includes the steps of: (a) preparing a netlist in which a plurality of cells are connected to one another through a net, and performing hierarchical clustering on the respective cells so as to successively group the cells to be connected to each other through a larger number of nets; (b) allowing the nets in the netlist to belong to any of hierarchical layers of the hierarchical clustering in the step (a), respectively, so as to allow the nets in the netlist to belong to the “n”th hierarchical layer when a group that collectively includes all the cells connected to the nets is present in groups on the “n”th hierarchical layer, but is absent in groups on the “(n−1)”th hierarchical layer; (c) setting estimated values of lengths of routing in the nets in the netlist at a smaller value as the hierarchical layer to which the nets belong is lower in order; (d) summing the estimated values of the lengths of routing in the nets in the netlist on the basis of the setting in the step (c) to calculate an estimated value of a total length of routing in the netlist; and (e) dividing the estimated value of the total length of routing in the netlist by a circuit scale in the netlist to calculate a difficulty level of routing in the netlist.

The method according to the present invention can bring about the following advantages. That is, an estimated value of a length of routing in a net connecting between two cells that strongly tend to be placed so as to adjoin to each other can be set at a smaller value. Thus, the estimated value of the length of routing can be set at a value approximate to an actual length of routing; therefore, the difficulty level of routing can be calculated with good calculating accuracy. Moreover, the difficulty level of routing is calculated with the use of a netlist. Therefore, the difficulty level of routing can be calculated at a high processing speed.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a flowchart of a method according to a first embodiment of the present invention;

FIG. 2 shows one example of hierarchical clustering in the first embodiment;

FIG. 3 shows a group on a first hierarchical layer and a net belonging to the first hierarchical layer (i.e., shows a netlist on the first hierarchical layer) in the first embodiment;

FIG. 4 shows a group on a second hierarchical layer and a net belonging to the second hierarchical layer (i.e., shows a netlist on the second hierarchical layer) in the first embodiment;

FIG. 5 shows a group on a third hierarchical layer and a net belonging to the third hierarchical layer (i.e., shows a netlist on the third hierarchical layer) in the first embodiment;

FIG. 6 shows one example of a netlist;

FIG. 7 shows one example of another netlist which is equal to the netlist shown in FIG. 6 in terms of the number of cells, the number of nets and the number of fanouts;

FIG. 8 is a flowchart of a method according to a third embodiment of the present invention;

FIG. 9 shows one example of a netlist prior to change of a connection status of nets in the third embodiment;

FIG. 10 shows a state that the connection status of a part of the nets in the netlist shown in FIG. 9 is canceled;

FIG. 11 shows a state that a connection status of a net is newly established in the netlist shown in FIG. 10; and

FIG. 12 schematically shows an entire design flow of LSI in a case of using the method according to the first embodiment.

### DESCRIPTION OF THE PREFERRED EMBODIMENTS

### First Embodiment

A method according to a first embodiment of the present invention involves calculating a difficulty level of routing in a circuit with the use of a netlist prepared by RTL design and logic synthesis for the circuit, prior to layout design for the circuit.

First, description will be given of an outline of the method according to this embodiment. The method involves: performing hierarchical clustering on cells C in a netlist NR on the basis of a connection strength between the two cells C; setting estimated values of lengths of routing in nets N at different values for each hierarchical layer; summing the estimated values of the lengths of routing in the nets N throughout all the hierarchical layers to calculate a total length of routing; and calculating a difficulty level of routing with the use of the total length of routing, as shown in FIG. 2. Herein, the estimated values of the lengths of routing in the nets N are set such that the net N on the lower hierarchical layer has the smaller estimated value of the length of routing. By the hierarchical clustering, moreover, the cells C to be connected to each other through a larger number of nets N are grouped in a single group.

A difficulty level of routing (a difficulty level of layout) is determined on the basis of a length of routing per unit area (i.e., a total length of routing/a circuit scale in a netlist). If the difficulty level of routing has a value larger than a predetermined reference value, it is determined that a routing operation is difficult to perform. Then, RTL design and logic synthesis are newly performed in order to improve a netlist NR.

As described above, the method according to this embodiment brings about the following advantage. That is, the difficulty level of routing in the circuit is calculated with the use of the netlist NR, prior to the layout design. If it is determined that the routing operation is difficult to perform, the netlist NR is improved for preventing the layout design, which requires much processing time, from being repeatedly performed (see FIG. 12), leading to reduction of a period of time for an entire design flow. Moreover, an advantage similar to the advantage described above can be expected in such a manner that a process of preparing a netlist NR with a lower difficulty level of routing is executed with the use of a synthesis tool (e.g., a logic synthesis tool, a high-order synthesis tool) in consideration of the difficulty level of routing in the netlist NR.

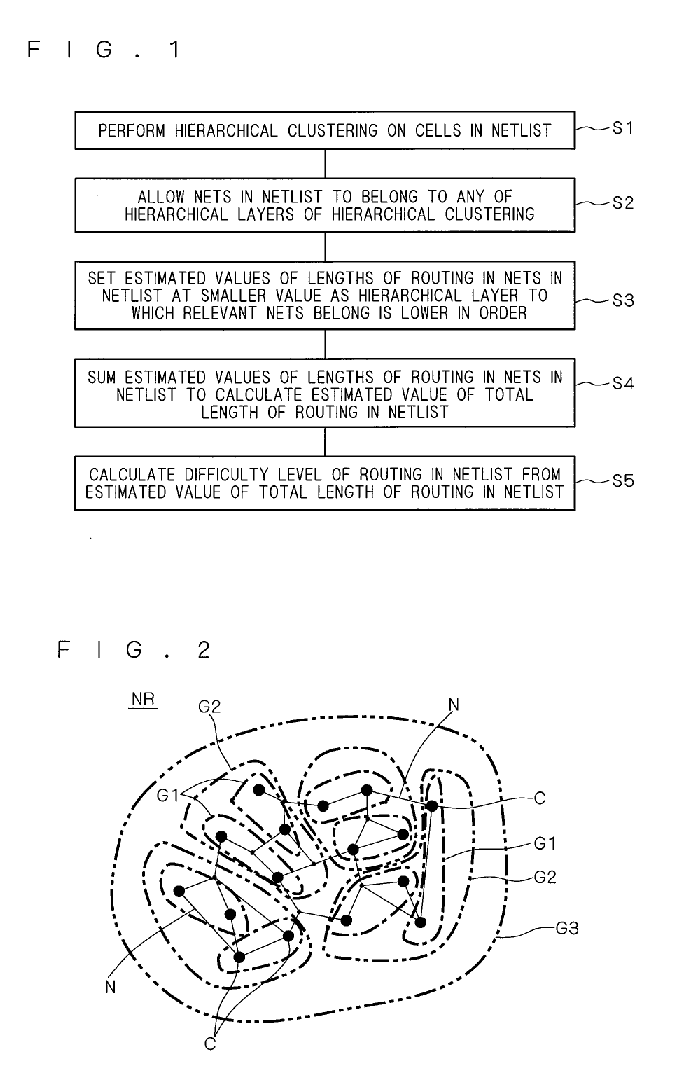

With reference to FIG. 1, next, description will be given of details of the method according to this embodiment.

In step S1, first, hierarchical clustering (hierarchical grouping) is performed on cells C in a netlist NR obtained as a result of logic synthesis (i.e., a netlist in which a plurality of cells C in a circuit are connected to one another through a plurality of nets N) such that the cells C to be connected to each other through a larger number of nets are successively grouped as shown in FIG. 2.

More specifically, a few (e.g., two) cells C, which are defined as a member, in the netlist NR are grouped, so that a plurality of groups G1 are formed on a first hierarchical layer. Herein, cells C to be connected to each other through a larger number of nets N are preferentially grouped such that the respective groups G1 are equal to each other in terms of a size (a sum of areas of the cells C in each group G1). Then, a few (e.g., two) groups G1, which are defined as a member, on the first hierarchical layer are grouped, so that a plurality of groups G2 are formed on a second hierarchical layer. Also herein, groups G1 to be connected to each other through a larger number of nets N are preferentially grouped such that the respective groups G2 are equal to each other in terms of a size (a sum of areas of the cells C in each group G2). Typically, a few groups Gn, which are defined as a member, on a “n”th hierarchical layer are grouped, so that a plurality of groups G(n+1) are formed on a “(n+1)th” hierarchical layer. Herein, groups Gn to be connected to each other through a larger number of nets N are preferentially grouped such that the respective groups G(n+1) are equal to each other in terms of a size (a sum of areas of the cells C in each group G(n+1)). The hierarchical clustering is performed by successively and repeatedly performing the grouping described above until formation of one ultimate group. As a method of the grouping, there have been known various existing methods (refer to, e.g., Charles J. Alpert, Jen-Hsin Huang, Andrew B. Kahng, “Multilevel Circuit Partitioning”, Proceedings of Design Automation Conference, pp. 530-533, 1997).

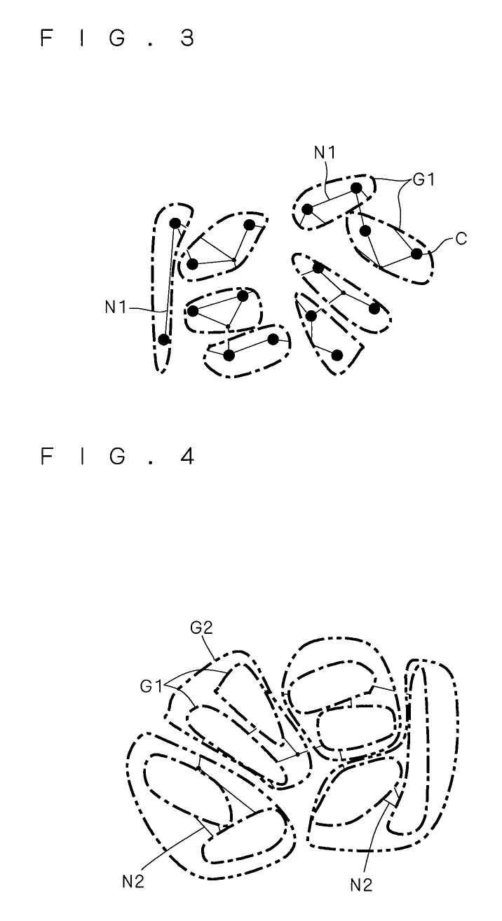

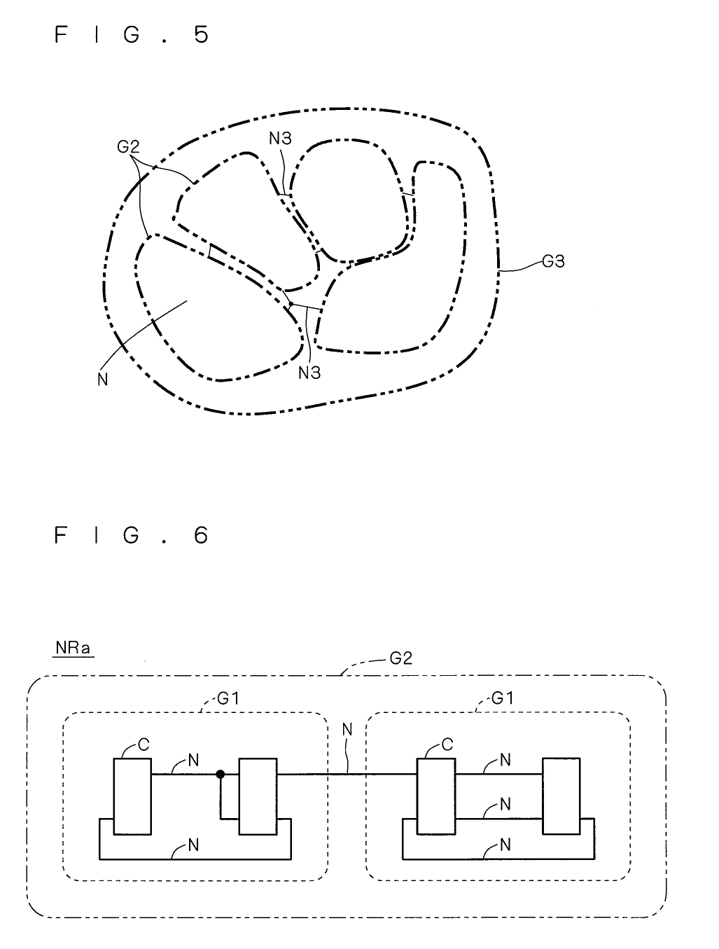

In step S2, next, the nets N in the netlist NR are allowed to belong to any of the hierarchical layers of the hierarchical clustering in step S1 such that the nets N in the netlist NR are allowed to belong to the “n”th hierarchical layer if a group that collectively includes all the cells C connected to one another through the nets N are present in the groups Gn on the “n”th hierarchical layer, but is absent in the groups G(n−1) on the “(n−1)”th hierarchical layer. Of the nets N shown in FIG. 2, herein, the nets N extracted as shown in FIG. 3 correspond to the nets N1 belonging to the first hierarchical layer, the nets N extracted as shown in FIG. 4 correspond to the nets N2 belonging to the second hierarchical layer, and the nets N extracted as shown in FIG. 5 correspond to the nets N3 belonging to the third hierarchical layer.

In step S3, next, estimated values h of lengths of routing in the nets N in the netlist NR are set at a smaller value as the hierarchical layer to which the nets N belong is lower in order. As the estimated value h of the length of routing in each net N, for example, there is used a square root of an average size of the groups G on the hierarchical layer to which the relevant net N belongs (i.e., an average value of a sum of areas S of the cells C in each group G (the number of cells×S)). The number of cells in each group G1 is two in average; therefore, the estimated value h1 of the length of routing in the net N1 is calculated from an equation, h1=(2S)^{1/2}≅1.4×S^{1/2}. Further, the number of cells in each group G2 is four in average; therefore, the estimated value h2 of the length of routing in the net N2 is calculated from an equation, h2=(4S)^{1/2}=2×S^{1/2}. In addition, the number of cells in each group G3 is 16; therefore, the estimated value h3 of the length of routing in the net N3 is calculated from an equation, h3=(16S)^{1/2}=4×S^{1/2}.

In step S4, next, the estimated values h of the lengths of routing in the nets N in the netlist NR are summed to calculate an estimated value H of a total length of routing in the netlist NR. Herein, the estimated value H is calculated from an equation, H=(the number of nets N1)×h1+(the number of nets N2)×h2+(the number of nets N3)×h3.

In step S5, next, the estimated value H of the total length of routing in the netlist NR is divided by a circuit scale R in the netlist NR to calculate a difficulty level P of routing in the netlist NR (P=H/R). Herein, as the circuit scale R in the netlist NR, for example, there is used the sum of the areas S of the cells C in the netlist NR (i.e., the total number of cells in the netlist NR×S). As described above, the difficulty level P of routing is calculated with the use of the netlist by the method according to this embodiment. Herein, the difficulty level P of routing calculated as described above is compared with a reference value set in accordance with a type of a circuit. Then, it is determined whether or not the difficulty level of routing has a value higher than the reference value.

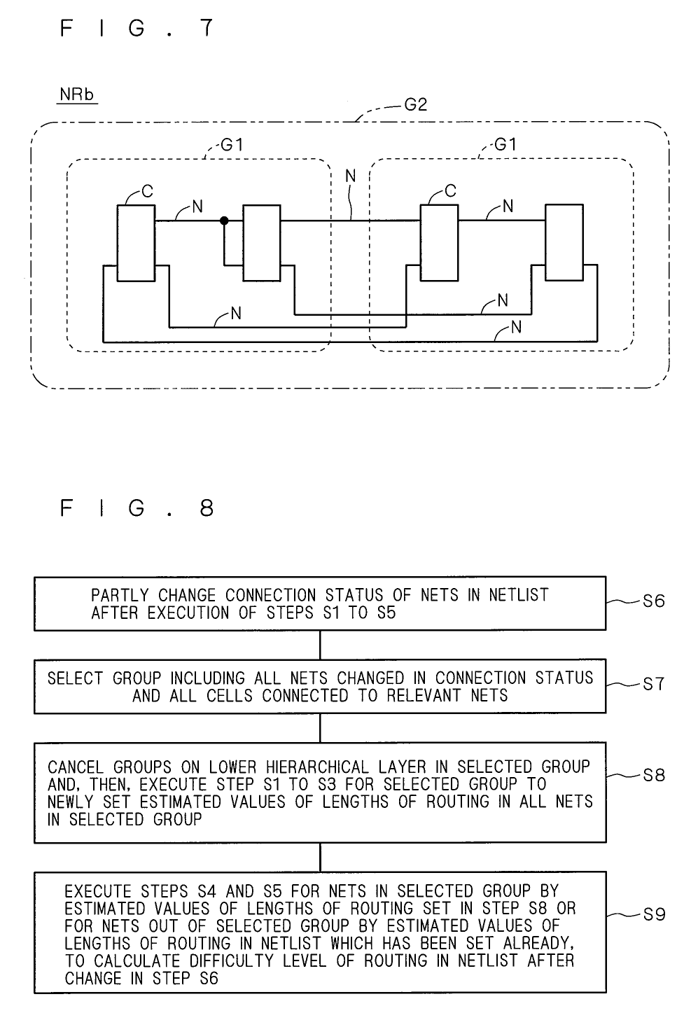

Next, a study will be made of a comparison between the method for calculating the difficulty level of routing in the netlist according to this embodiment and a conventional method for calculating the difficulty level of routing on the basis of the number of fanouts. A netlist NRa shown in FIG. 6 and a netlist NRb shown in FIG. 7 are equal to each other in terms of the number of cells (4), the number of nets (6) and the total number of fanouts (7), but are different from each other in terms of a connection status of the nets N. It is apparent from FIGS. 6 and 7 at a glance that a routing operation in the netlist NRb is harder than that in the netlist NRa.

In the case of the netlist NRa, the number of nets N1 belonging to the first hierarchical layer is 5, the number of nets N2 belonging to the second hierarchical layer is 1, the estimated value h1 of the length of routing in the net N1 is calculated from an equation, h1=1.4×S^{1/2}, and the estimated value h2 of the length of routing in the net N2 is calculated from an equation, h2=2×S^{1/2}; therefore, the difficulty level P1a of routing in the netlist NRa is calculated from an equation, P1a=(5×1.4×S^{1/2b +1×2}×S^{1/2})1(4×S)=8×S^{1/2}/(4×S), in the method according to this embodiment. On the other hand, the total number of fanouts is 7; therefore, the difficulty level P2a of routing in the netlist NRa is equal to the average number of fanouts (the number of fanouts/the number of nets=7/6), in the calculating method based on the number of fanouts.

In the case of the netlist NRb, moreover, the number of nets N1 belonging to the first hierarchical layer is 2, the number of nets N2 belonging to the second hierarchical layer is 4, the estimated value h1 of the length of routing in the net N1 is calculated from the equation, h1=1.4×S^{1/2}, and the estimated value h2 of the length of routing in the net N2 is calculated from the equation, h2=2×S^{1/2}; therefore, the difficulty level P1b of routing in the netlist NRb is calculated from an equation, P1b=(2×1.4×S^{1/2}+4×2×S^{1/2})/(4×S)=10.8×S^{1/2}/(4×S), in the method according to this embodiment. On the other hand, the total number of fanouts is 7; therefore, the difficulty level P2b of routing in the netlist NRb is equal to the average number of fanouts (the number of fanouts/the number of nets=7/6), in the calculating method based on the number of fanouts.

From these results, in the method according to this embodiment, the difficulty level P1a of routing is smaller than the difficulty level P1b of routing, so that it is determined that the routing operation in the netlist NRb is harder than the routing operation in the netlist NRa. Therefore, the difficulty level of routing is appropriately determined. On the other hand, in the calculating method based on the number of fanouts, the difficulty level P2a of routing is equal to the difficulty level P2b of routing, so that it is determined that the difficulty level P2a of routing is equal to the difficulty level P2b of routing. Therefore, the difficulty level of routing is not appropriately determined. Hence, it can be said that the method according to this embodiment is higher than the calculating method based on the number of fanouts in terms of accuracy of calculating the difficulty level of routing.

Next, consideration will be made to the reasons therefor. In the method according to this embodiment, the hierarchical clustering is performed on the basis of the connection strength between the two cells C (i.e., the number of nets N connecting between the two cells C). Herein, the cells C which are high in connection strength (i.e., which are connected to each other through a larger number of nets N) are grouped in a single group for the following reason. That is, the cells C which are high in connection strength tend to be placed so as to adjoin to each other by a program for placement and routing. The nets N included in the single group tend to be set shorter in length of routing by the program for placement and routing in comparison with the nets N that connect between two different groups.

In consideration of this tendency, the estimated values h of the lengths of routing in the nets N included in the single group (i.e., the nets N belonging to the lower hierarchical layer) are set smaller than the estimated values h of the lengths of routing in the nets N that connect between the two different groups (i.e., the nets N belonging to the higher hierarchical layer), so that the difficulty level of routing is calculated in consideration of the connection strength between the two cells C in the method according to this embodiment. On the other hand, the difficulty level of routing is calculated without taking the connection strength between the two cells C into consideration in the calculating method based on the number of fanouts. Hence, the method according to this embodiment is higher than the calculating method based on the number of fanouts in terms of accuracy of calculating the difficulty level of routing.

Next, a study will be made of a comparison between the method for calculating the difficulty level of routing in the netlist according to this embodiment and a method for calculating the difficulty level of routing by means of high-speed placement and routing. In the method according to this embodiment, the difficulty level of routing in the circuit is calculated with the use of the netlist NR prior to the layout design. Of course, the method according to this embodiment is higher in processing speed than the calculating method by the high-speed placement and routing because the calculating method by the high-speed placement and routing uses a result of the layout design.

As described above, the method according to this embodiment involves: performing the hierarchical clustering on the cells C in the netlist NR so as to successively group the cells to be connected to each other through a larger number of nets (i.e., the cells that strongly tend to be placed so as to adjoin to each other); allowing the nets N in the netlist NR to belong to any of the hierarchical layers of the hierarchical clustering so as to allow the nets N in the netlist NR to belong to the “n”th hierarchical layer when the group G that collectively includes all the cells C connected to one another through the nets N is present in the groups Gn on the “n”th hierarchical layer, but is absent in the groups G(n−1) on the “(n−1)”th hierarchical layer; and setting the estimated values h of the lengths of routing in the nets N in the netlist NR at a smaller value as the hierarchical layer to which the nets N belong is lower in order. Therefore, a smaller value can be set as the estimated value of the length of routing in the net connecting between the cells that strongly tend to be placed so as to adjoin to each other. Thus, the estimated value of the length of routing in each net N can be set at a value approximate to an actual length of routing; therefore, the difficulty level of routing can be calculated with good calculating accuracy. In addition, the difficulty level of routing is calculated with the use of the netlist NR. Therefore, the difficulty level of routing can be calculated at a high processing speed.

Moreover, the estimated value h of the length of routing in each net N is the square root of the average value of the sum of the areas of the cells C in the groups G on the hierarchical layer to which the relevant net N belongs. Therefore, the estimated value h of the length of routing in each net N can be set at a smaller value as the hierarchical layer to which the relevant net N belongs is lower in order, with a simple equation.

### Second Embodiment

A method according to a second embodiment of the present invention is different from the method according to the first embodiment in terms of the following point. That is, the estimated value h of the length of routing in each net N in the netlist NR is set at a smaller value as the hierarchical layer to which the relevant net N belongs is lower in order and, also, is set a smaller value as the number of fanouts in the relevant net N is smaller. More specifically, as the estimated value h of the length of routing in each net N belonging to the “n”th hierarchical layer, there is used a value obtained by multiplying the square root of the average size of the groups Gn on the “n”th hierarchical layer (i.e., the average value of the sum of the areas S of the cells C in the respective groups G) by a fanout coefficient. Herein, the fanout coefficient corresponds to an actual value defined for each number of fanouts, and becomes larger as the number of fanouts is larger. As the fanout coefficient, there is used a value statistically calculated from a result of placement and routing of an actual circuit and, then, stored in a table format. The method according to this embodiment is equal to the method according to the first embodiment except processes other than the process described above; therefore, detailed description thereof will not be given here.

As described above, the method according to this embodiment can bring about the following advantages. That is, the estimated value h of the length of routing in each net N in the netlist NR is set at a smaller value as the hierarchical layer to which the relevant net N belongs is lower in order and, also, is set at a smaller value as the number of fanouts of the net N is smaller. Therefore, consideration can be made to not only the connection strength between the two cells C, but also the number of fanouts, so that the difficulty level of routing can be calculated with better calculating accuracy.

As the estimated value h of the length of routing in each net N belonging to the “n”th hierarchical layer, moreover, there is used the value obtained by multiplying the square root of the average size of the groups Gn on the “n”th hierarchical layer by the fun-out coefficient. Therefore, consideration can be made to not only the connection strength between the two cells C, but also the number of fanouts, with the use of a simple equation.

### Third Embodiment

A method according to a third embodiment of the present invention is different from the method according to the first embodiment in the following point. That is, in a case where the connection status of the nets N in the netlist NR is partly changed after execution of the processes in steps S1 to S5, a difficulty level P of routing in the netlist NR is calculated. With reference to FIG. 8, hereinafter, description will be given of the method according to this embodiment.

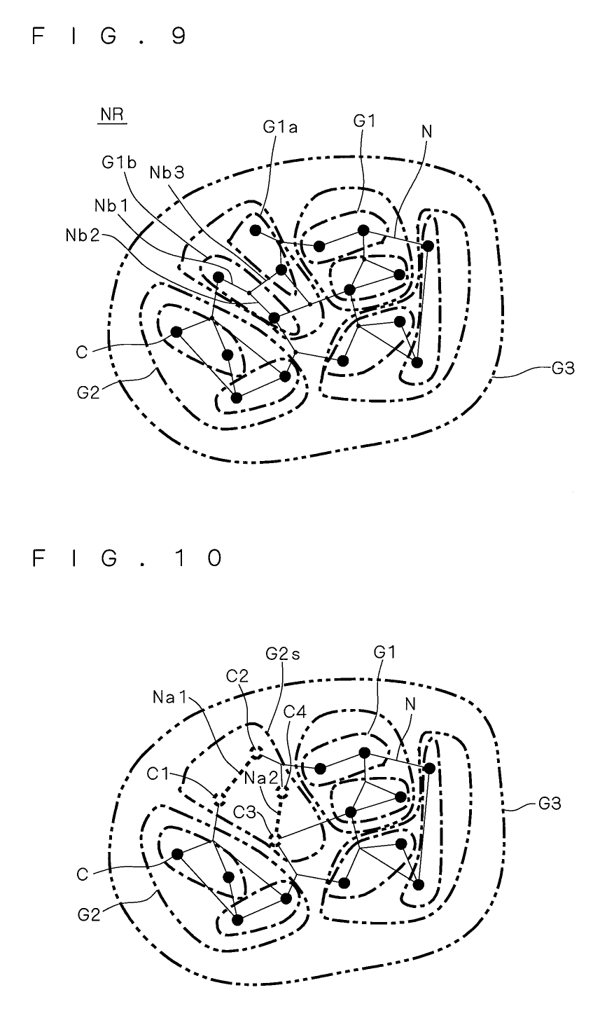

In step S6, first, the connection status of the nets N in the netlist NR is partly changed after execution of the processes in steps S1 to S5. For example, the nets Nb1, Nb2 and Nb3 (FIG. 9) are deleted in the netlist NR. As shown in FIG. 10, then, a net Na1 is newly connected between the cell C1 and the cell C2, and a net Na2 is newly connected between the cell C3 and the cell C4, in place of the nets Nb1, Nb2 and Nb3.

In step S7, next, the group G that collectively includes all the nets Na1 and Na2 changed in connection status as well as all the cells C1, C2, C3 and C4 connected to the nets Na1 and Na2 is selected from the groups G on the respective hierarchical layers other than the highest hierarchical layer in the netlist NR. Herein, the group G that collectively includes all the nets Na1 and Na2 as well as all the cells C1, C2, C3 and C4 is the group on the lowest hierarchical layer (the lower hierarchical layer) (the group G2s on the second hierarchical layer in this embodiment).

Herein, the connection status of the nets N is changed only at a part (a locally centralized portion) of the netlist NR. Therefore, the group G2s that collectively includes all the nets Na1 and Na2 changed in connection status as well as all the cells C1, C2, C3 and C4 connected to the nets Na1 and Na2 is selected as the group G that includes all the nets Na1 and Na2 as well as all the cells C1, C2, C3 and C4. If the connection status of the nets N is changed at plural portions (plural portions spatially separated from one another) in the netlist NR, the plural groups G that include all the nets Na changed in connection status and part of the cells C connected to the nets Na may be selected as the group G that includes all the nets Na and all the cells C. This configuration allows selection of the group G lower in hierarchical layer than the group G that collectively includes all the nets Na and all the cells C, leading to reduction of processes to be executed later. Also in the case of selecting the group G that includes part of the cells C, desirably, the group G on the lowest hierarchical layer (the lower hierarchical layer) is selected as in the case described above.

In step S8, next, the grouping of each group (the groups G1a and G1b in this embodiment (FIG. 9)) on the lower hierarchical layer included in the selected group G2s is canceled, all the cells (the cells C1, C2, C3, C4 in this embodiment) and all the nets (the nets Na1, Na2 in this embodiment) included in the group G2s are subjected to the processes in steps S1 to S3, and the estimated values h of the lengths of routing in all the nets Na1 and Na2 included in the group G2s are newly set. Herein, in a case where all the cells C to be connected to one another through the relevant nets N are included in the single group G, the nets N are also included in the single group G. Alternatively, in a case where one of the cells C connected to the nets N is included in the group G, it may be determined that the nets N are included in the group G.

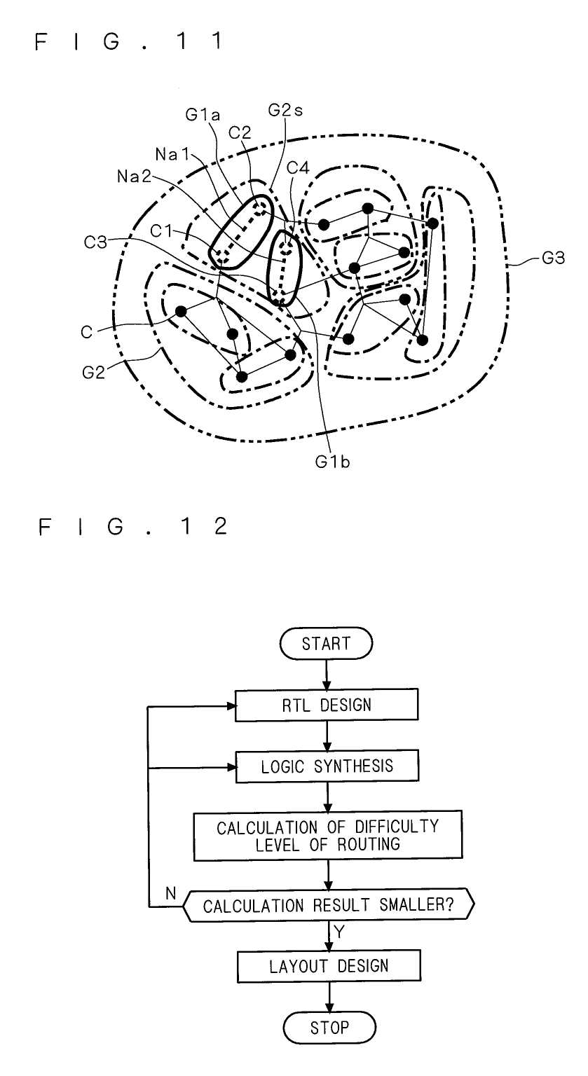

In step S8, more specifically, the hierarchical clustering in step S1 is performed only on all the cells C1, C2, C3 and C4 included in the group G2s on the basis of the changed connection status of the nets N. As shown in FIG. 11, thus, the cells C1 and C2 are newly grouped in a group G1a on the first hierarchical layer, and the cells C3 and C4 are newly grouped in a group G1b on the first hierarchical layer. Next, the respective nets Na1 and Na2 included in the group G2s are allowed to belong to any of the hierarchical layers of the hierarchical clustering, as in the case of process in step S2. Herein, the nets Na1 and Na2 are allowed to belong to the first hierarchical layer, for example. Next, the estimated values h of the lengths of routing in the respective nets Na1 and Na2 included in the group G2s are set as in the case of the process in step S3. Herein, the respective nets Na1 and Na2 belong to the first hierarchical layer; therefore, the estimated value h1 is nearly equal to a value calculated from an equation of 1.4×S^{1/2}.

In step S9, next, a difficulty level P of routing in the netlist NR after the change of the connection status of the nets N is calculated as in the case of the process in step S4, with the use of the estimated values h of the lengths of routing, which are newly set in step S8, with regard to the nets Na1 and Na2 which are included the selected group G2s or with the use of the estimated values h of the lengths of routing, which have been already set, with regard to the nets N which are not included in the group G2s.

As described above, the method according to this embodiment brings about the following advantages. That is, when the connection status of part of the nets N in the netlist NR is changed, only the group (the group G2s in this embodiment) on the lowest hierarchical layer selected from the groups G that collectively include the changed portion is subjected to the processes in steps S1 to S3. Then, the estimated values h of the lengths of routing in the nets which are included in the group G2s are newly set, but the estimated values h of the lengths of routing, which have been already set, in the nets which are not included in the group G2s is used as it is. Therefore, it is unnecessary to execute the processes in steps S1 to S3 on the entire netlist NR after the change. Thus, the difficulty level of routing can be calculated at a higher processing speed.

### Fourth Embodiment

In the first to third embodiments, the netlist NR to be used is a netlist on a cell basis. However, the netlist NR to be used may be a netlist on a functional block basis, such as an adder or a selector, or a netlist on an LSI chip basis. In other words, the cell may be a functional block or an LSI chip. This configuration also brings about advantages similar to those described above.

The present invention is principally applicable to RTL design, high-order synthesis, logic design, logic synthesis and the like for general large-scale digital LSI. The present invention is applied to a netlist serving as an intermediate result of design (synthesis) in order to calculate a difficulty level of routing. If the difficulty level of routing is high, such design (synthesis) is performed again in order to prepare a netlist with a low difficulty level of routing.

While the invention has been shown and described in detail, the foregoing description is in all aspects illustrative and not restrictive. It is therefore understood that numerous modifications and variations can be devised without departing from the scope of the invention.

What is claimed is:

1. A method for calculating a difficulty level of routing in a netlist, comprising the steps of:
(a) preparing a netlist in which a plurality of cells are connected to one another through a net, and performing hierarchical clustering on said respective cells so as to successively group the cells to be connected to each other through a larger number of nets;
(b) allowing the nets in said netlist to belong to any of hierarchical layers of the hierarchical clustering in said step (a), respectively, so as to allow the nets in said netlist to belong to the “n”th hierarchical layer when a group that collectively includes all said cells connected to the nets is present in groups on the “n”th hierarchical layer, but is absent in groups on the “(n−1)”th hierarchical layer;
(c) setting estimated values of lengths of routing in the nets in said netlist at a smaller value as the hierarchical layer to which the nets belong is lower in order;
(d) summing the estimated values of the lengths of routing in the nets in said netlist on the basis of the setting in said step (c) to calculate an estimated value of a total length of routing in said netlist; and
(e) dividing the estimated value of said total length of routing in said netlist by a circuit scale in said netlist to calculate a difficulty level of routing in said netlist.

2. The method according to claim 1, wherein
the estimated value of said length of routing in each net, which is set in said step (c), is a square root of an average size of the groups on the hierarchical layer to which the net belongs.

3. The method according to claim 1, wherein
the circuit scale in said netlist, which is used in said step (e), is a sum of areas of the cells in said netlist.

4. The method according to claim 1, wherein
in said step (c), the estimated value of the length of routing in each net in said netlist is set at a smaller value as the hierarchical layer to which the net belongs is lower in order and, also, is set at a smaller value as the number of fanouts in the net is smaller.

5. The method according to claim 4, wherein
in said step (c), the estimated value of the length of routing in the net belonging to the “n”th hierarchical layer is a value obtained by multiplying a square root of an average size of the groups on the “n”th hierarchical layer by a fanout coefficient.

6. The method according to claim 1, in a case where a connection status of the nets in said netlist is partly changed after execution of said steps (a) to (e), further comprising the steps of:
(f) partly changing the connection status of the nets in the netlist after execution of said step (e);
(g) selecting a group collectively or partly including all the nets changed in connection status and all the cells connected to the nets from the groups on the respective hierarchical layers other than the highest hierarchical layer of the hierarchical clustering in said step (a);
(h) canceling the grouping in each group on the lower hierarchical layer included in said selected group and, then, executing said steps (a) to (c) for the cells and the nets included in said selected group to newly set the estimated values of the lengths of routing in all the nets included in said selected group; and
(i) executing said steps (d) and (e) for the nets which are included in said selected group with the use of the estimated values of the lengths of routing which are set in said step (h) and for the nets which are not included in said selected group with the use of the estimated values of the lengths of routing which have been already set, to calculate a difficulty level of routing in said netlist in which the connection status of the nets is changed in said step (f).

7. The method according to claim 6, wherein
in said step (f), the group on the lower hierarchical layer is selected from the groups including all the nets changed in connection status and all the cells connected to the nets.

8. The method according to claim 1, wherein
said cell is a functional block or an LSI chip.
